(19) United States
(12) Patent Application Publication
(10) Pub. No.: US 2017/0090684 A1
(43) Pub. Date: Mar. 30, 2017

(54) METHOD AND APPARATUS FOR PROCESSING INFORMATION

(71) Applicant: Xiaomi Inc., Beijing (CN)

(72) Inventors: Qian WANG, Beijing (CN); Jingsong YANG, Beijing (CN)

(73) Assignee: Xiaomi Inc.

(21) Appl. No.: 15/222,375

(22) Filed: Jul. 28, 2016

(30) Foreign Application Priority Data
Sep. 28, 2015 (CN) 201510627227.3

(51) Int. Cl. G06F 3/0481; G06F 17/27; G06F 3/0484; G06F 17/22

(52) U.S. Cl. CPC G06F 3/0481; G06F 17/2235; G06F 17/27; G06F 3/0484

(57) ABSTRACT

A method for processing information includes capturing a display interface when detecting a capture operation instruction, performing a content analysis on the captured display interface and determining whether the captured display interface contains content with a preset format, and adding an operation control corresponding to the content into the captured display interface and storing the captured display interface with the added operation control if the captured display interface contains the content.

### CROSS REFERENCE TO RELATED APPLICATION

This application is based upon and claims a priority to Chinese Patent Application No. 201510627227.3, filed with the State Intellectual Property Office of P. R. China on Sep. 28, 2015, the entire contents of which are incorporated herein by reference.

### TECHNICAL FIELD

The present disclosure relates to computer technology and, more particularly, to a method and apparatus for processing information.

### BACKGROUND

A screen capture application is commonly used by users as a way of storing information. If a user wishes to store content in a current display interface of a terminal, the user can capture the current display interface by means of a screenshot and store it. Currently, a stored screenshot will be displayed as a picture as a whole, but independent elements in the screenshot cannot be displayed separately.

### SUMMARY

In accordance with the present disclosure, there is provided a method for processing information including capturing a display interface when detecting a capture operation instruction, performing a content analysis on the captured display interface and determining whether the captured display interface contains content with a preset format, and adding an operation control corresponding to the content into the captured display interface and storing the captured display interface with the added operation control if the captured display interface contains the content.

Also in accordance with the present disclosure, there is provided a device for processing information including a processor and a memory storing instructions. The instructions, when executed by the processor, cause the processor to capture a display interface when detecting a capture operation instruction, perform a content analysis on the captured display interface and determine whether the captured display interface contains content with a preset format, and add an operation control corresponding to the content into the captured display interface and store the captured display interface with the added operation control if the captured display interface contains the content.

Also in accordance with the present disclosure, there is provided a non-transitory computer-readable storage medium having stored therein instructions that, when executed by a processor of a device, cause the device to capture a display interface when detecting a capture operation instruction, perform a content analysis on the captured display interface and determine whether the captured display interface contains content with a preset format, and add an operation control corresponding to the content into the captured display interface and store the captured display interface with the added operation control if the captured display interface contains the content.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a method for processing information according to an exemplary embodiment;

FIG. 2 is a flow chart showing a method for processing information according to another exemplary embodiment;

FIG. 3 is a block diagram showing an apparatus for processing information according to an exemplary embodiment;

FIG. 4 is a block diagram showing an apparatus for processing information according to another exemplary embodiment;

FIG. 5 is a block diagram showing an information processing module in the apparatus shown in FIG. 4;

FIG. 6 is a block diagram showing a device for displaying content according to an exemplary embodiment.

According to the above-described accompanying drawings, embodiments of the present disclosure are provided, and will be described in more detail hereafter. These accompanying drawings and corresponding description are not intended to limit the scope of the disclosure by any means, and the concepts of the present disclosure is explained to those skilled in the art with reference to specific embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims. Methods and apparatuses consistent with the present disclosure can be implemented, for example, in a terminal, such as a mobile phone, a tablet, or a smart TV.

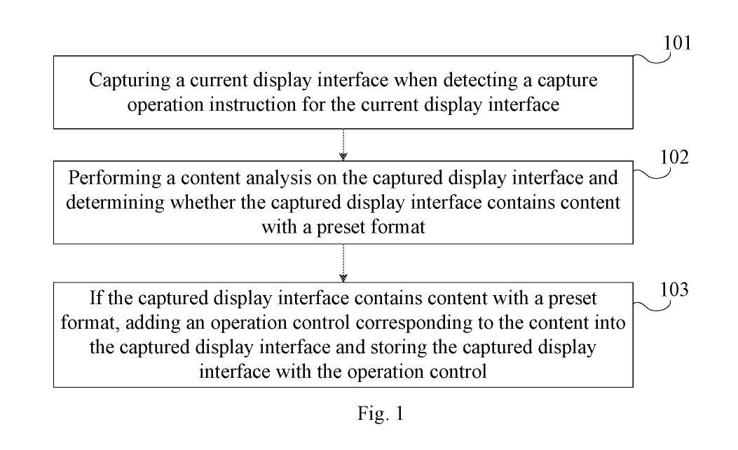

FIG. 1 is a flow chart showing a method for processing information according to an exemplary embodiment. Referring to FIG. 1, at 101, a current display interface is captured when detecting a capture operation instruction for the current display interface. At 102, a content analysis is performed on the captured display interface to determine whether the captured display interface contains content with a preset format. At 103, if the captured display interface contains content with a preset format, an operation control corresponding to the content with the preset format is added into the captured display interface and the captured current display interface with the added operation control is stored.

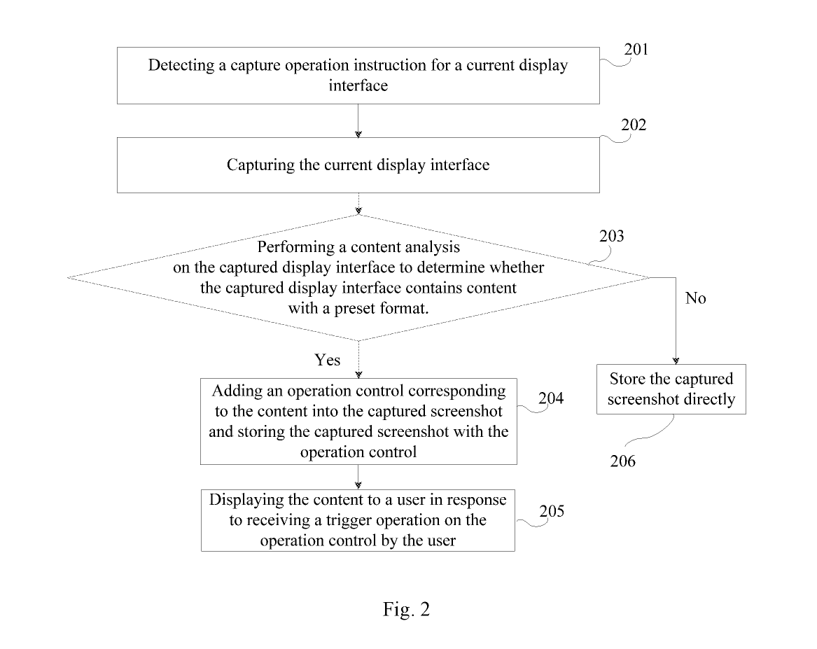

FIG. 2 is a flow chart showing a method for processing information according to another exemplary embodiment. Referring to FIG. 2, at 201, a capture operation instruction for a current display interface of a terminal is detected.

At 202, the current display interface is captured.

At 203, a content analysis is performed on the captured display interface and it is determined whether the captured display interface contains content with a preset format.

In some embodiments, the content with the preset format can be a voice message, a video, music, text, or a picture. The content analysis can be performed on the captured display interface to read the content line by line, so as to determine whether the captured display interface contains a voice message, a video, music, text, or a picture.

If the captured display interface contains content with a preset format (203: Yes), the process flow proceeds to 204, at which an operation control corresponding to the content with the preset format is added into the captured display interface and the captured display interface with the added operation control is stored.

In some embodiments, to add the operation control corresponding to the content with the preset format into the captured display interface, a source of the content with the preset format is obtained, a link corresponding to the content with the preset format is generated according to the obtained source, and the generated link is displayed at a preset location on the captured display interface in the form of an operation control.

In some embodiments, the source of the content with the preset format can be obtained by searching locally in the terminal or in a network server based on a keyword of the content with the preset format. If the source of the content with the preset format is stored locally in the terminal, a character string can be generated according to a preset random number generation algorithm. The generated character string can be used as the link address, and the content with the preset format and the link address are stored correspondingly. If the source of the content with the preset format is on the network, the network address of the content can be directly used as the link address, and can be stored in correspondence to the content with the preset format.

In some embodiments, when the operation control corresponding to the content with the preset format is added into the captured display interface, the operation control can be named according to the source of the content with the preset format and the name can be displayed on the captured display interface. For example, if the content with the preset format is from an application, the name of the application or the name of the content with the preset format can be used as the name of the operation control and can be displayed on the captured display interface. As another example, if the content with the preset format is music, the name of the music can be used to name the operation control.

At 205, the content with the preset format is displayed to the user in response to receiving a trigger operation on the operation control performed by the user. In some embodiments, when the trigger operation on the operation control performed by the user is received, the link address corresponding to the operation control is obtained, and the content with the preset format is obtained from the link address and displayed to the user.

On the other hand, at 203, if it is determined that the captured display interface does not contain content with a preset format (203: No), the process flow proceeds to 206, at which the captured display interface is stored directly.

Application examples consistent with the present disclosure in different scenarios will be described below in detail.

Scenario one: the user captures a voice conversation display interface. If the content analysis performed on the captured display interface reveals that the captured display interface contains a voice conversation message, then a link address pointing to the voice conversation message is generated for the voice conversation message stored locally, and the link address is displayed in the captured display interface in the form of the operation control. The captured display interface with the added operation control is stored. Then, if the user views the captured display interface, finds that the interface contains the voice conversation, and wishes to play back the content of the voice conversation, the user can touch the operation control. The terminal device can then call the corresponding voice conversation message from the local storage for playing according to the link address associated with the operation control.

Scenario two: the user captures a video playing interface. If the content analysis performed on the captured display interface reveals that the captured display interface is a frame of a video, then the video information is identified and searched for in the local storage or on the network to obtain a link address of the video information. The link address is displayed in the captured display interface in the form of the operation control, and then the captured display interface with the added operation control is stored. Then, if the user views the captured display interface, and finds that the interface is a frame of a video, and wishes to watch the video, the user can touch the operation control. The terminal device can then call the corresponding video from the local storage or the network for playing according to the link address associated with the operation control.

Scenario three: the user captures a music playing interface. If the content analysis performed on the captured display interface reveals that the captured display interface is a music playing interface, then the music information is identified and searched for in the local storage or on the network to obtain a link address of the music information. The link address is displayed in the captured display interface in the form of the operation control, and then the captured display interface with the added operation control is stored. Then, if the user views the captured display interface, finds that the interface includes music, and wishes to listen to the music, the user can touch the operation control. The terminal device can call the corresponding music from the local storage or the network for playing according to the link address associated with the operation control.

Scenario four: the user captures a text display interface. If the content analysis performed on the captured display interface reveals that the captured display interface shows a text display interface, then a link address of the display text is searched for in the local storage or on the network. The link address is displayed in the captured display interface in the form of the operation control, and then the captured display interface with the added operation control is stored. Then, if the user views the captured display interface, finds that the interface shows text and wishes to edit the text, the user can touch the operation control. The terminal device can obtain the corresponding text from the local storage or the network for displaying according to the link address associated with the operation control.

Exemplary apparatuses consistent with the present disclosure are described below. Operations of the exemplary apparatuses are similar to the exemplary methods described above, and thus their detailed description is omitted.

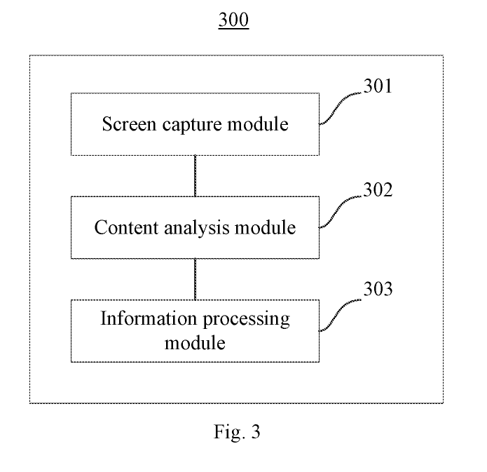

FIG. 3 is a block diagram showing an apparatus 300 for processing information according to an exemplary embodiment. The apparatus 300 includes a screen capture module 301, a content analysis module 302, and an information processing module 303. The screen capture module 301 is configured to capture a current display interface when detecting a capture operation instruction for the current display interface. The content analysis module 302 is configured to perform a content analysis on the captured display interface and to determine whether the captured display interface contains content with a preset format. The information processing module 303 is configured to add an operation control corresponding to the content with the preset format into the captured display interface and to store the captured current display interface with the added operation control if the captured display interface contains the content with the preset format.

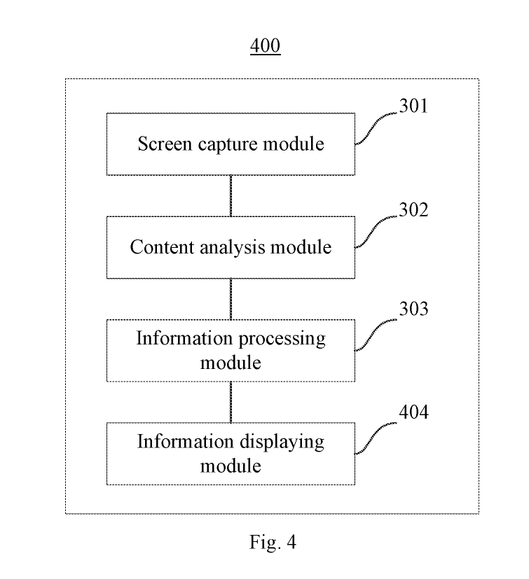

FIG. 4 is a block diagram showing an apparatus 400 for processing information according to another exemplary embodiment. The apparatus 400 includes the screen capture module 301, the content analysis module 302, the information processing module 303, and an information displaying module 404. The information displaying module 404 is configured to display the content with the preset format to a user when receiving a trigger operation on the operation control performed by the user.

The content with the preset format can be a voice message, a video, music, text, or a picture. The voice message, the video, the music, the text, or the picture can be identified from the captured display interface, and the corresponding operation control can be added, so that the user can perform an operation on the voice message, the video, the music, the text, or the picture in the captured display interface according to the corresponding operation control when subsequently viewing the captured display interface.

The information displaying module 404 is further configured to obtain a link address corresponding to the operation control when receiving the trigger operation on the operation control performed by the user, and to obtain the content with the preset format from the link address and to display the content to the user.

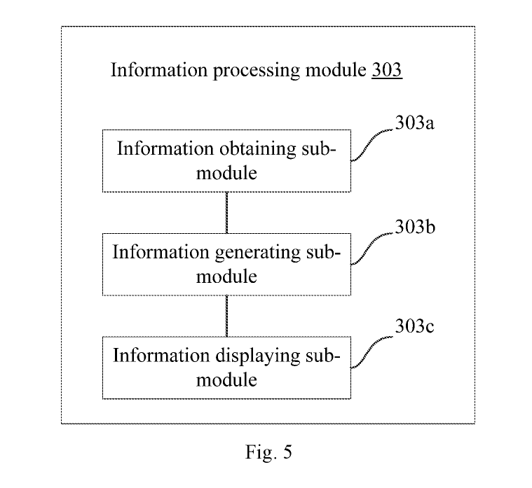

FIG. 5 is a block diagram showing an example of the information processing module 303. As shown in FIG. 5, the information processing module 303 includes an information obtaining sub-module 303a, an information generating sub-module 303b, and an information displaying sub-module 303c. The information obtaining sub-module 303a is configured to obtain a source of the content with the preset format. The information generating sub-module 303b is configured to generate a link address corresponding to the content with the preset format according to the source. The information displaying sub-module 303c is configured to display the link address in a form of the operation control at a preset location of the captured display interface.

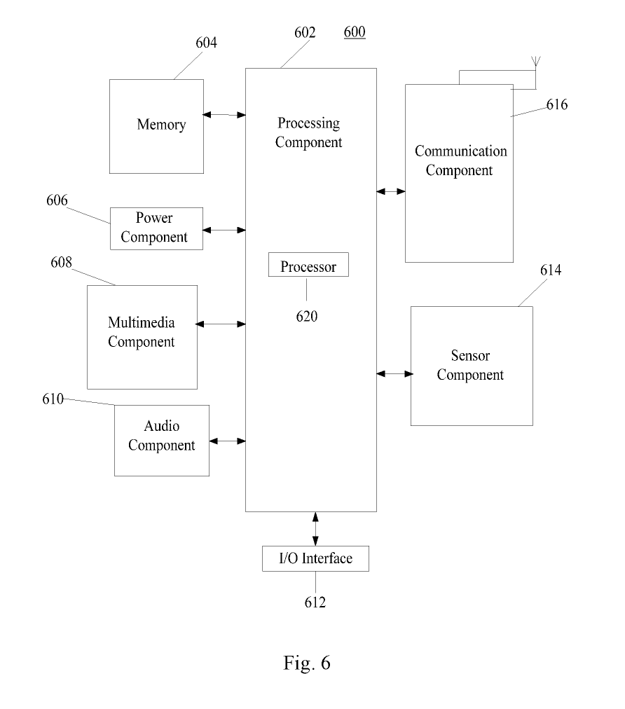

FIG. 6 is a block diagram showing a device 600 for processing information according to an exemplary embodiment. For example, the device 600 may be a mobile phone, a panel computer, a smart television, or the like.

Referring to FIG. 6, the device 600 includes one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 620 to execute instructions so as to perform all or a part of a method consistent with the present disclosure, such as one of the above-described exemplary methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, videos, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 is configured to provide power to various components of the device 600. The power component 606 may include a power management system, one or more power sources, and other components associated with the generation, control, and distribution of power in the device 600.

The multimedia component 608 includes a screen configured to provide an output interface between the device 600 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum when the device 600 is in an operation mode such as a photographing mode or a video mode. Each of the front camera and the rear camera may be a fixed optical lens system or have focus and optical zoom capability.

The audio component 610 is configured to output and/or input audio signals. For example, the audio component 610 includes a microphone configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a loud speaker to output audio signals.

The I/O interface 612 is configured to provide an interface between the processing component 602 and peripheral interface modules, such as a keyboard, a click wheel, buttons, and the like. The buttons may include, but are not limited to, a home button, a volume button, a starting button, or a locking button.

The sensor component 614 includes one or more sensors to provide status assessments of various aspects of the device 600. For instance, the sensor component 614 may detect an on/off status of the device 600, relative positioning of components (e.g., a display screen and a keypad) of the device 600. The sensor component 614 may further detect a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may further include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate a wired or wireless communication between the device 600 and other terminals. The device 600 can access a wireless network based on a communication standard, such as WiFi, 3Q or 4Q or a combination thereof. In one exemplary embodiment, the communication component 616 receives a broadcast signal or broadcast associated information from an external broadcast control system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

In exemplary embodiments, the device 600 may be implemented with one or more electronic elements such as application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method consistent with the present disclosure, such as one of the above-described exemplary methods.

In exemplary embodiments, there is further provided a non-transitory computer readable storage medium including instructions, such as the memory 604 including instructions executable by the processor 620 in the device 600 to perform a method consistent with the present disclosure, such as one of the above-described exemplary methods. For example, the non-transitory computer-readable storage medium may be a ROM, a RAM, a CD-ROM, a magnetic tape, a floppy disc, an optical data storage device, or the like.

According to the present disclosure, an operation control is added for content with a preset format in a captured display interface, so that a user can perform a corresponding operation on the content when later viewing the captured display interface. Further, different operation controls can be added for contents with different preset formats, so that the user can perform different operations on the different contents.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for processing information, comprising:
capturing a display interface when detecting a capture operation instruction;
performing a content analysis on the captured display interface and determining whether the captured display interface contains content with a preset format; and
adding an operation control corresponding to the content into the captured display interface and storing the captured display interface with the added operation control, if the captured display interface contains the content.

2. The method according to claim 1, wherein determining whether the captured display interface contains the content with the preset format includes determining whether the captured display interface contains a voice message, a video, music, text, or a picture.

3. The method according to claim 1, wherein adding the operation control into the captured display interface includes:
obtaining a source of the content;
generating a link address corresponding to the content according to the source; and
displaying the link address as the operation control at a preset location of the captured display interface.

4. The method according to claim 3, further comprising:
displaying the content in response to receiving a trigger operation on the operation control.

5. The method according to claim 4, wherein displaying the content includes:
obtaining the link address when receiving the trigger operation; and
obtaining the content from the link address and displaying the obtained content.

6. A device for processing information, comprising:
a processor; and
a memory storing instructions that, when executed by the processor, cause the processor to:
capture a display interface when detecting a capture operation instruction;
perform a content analysis on the captured display interface and determine whether the captured display interface contains content with a preset format; and
add an operation control corresponding to the content into the captured display interface and store the captured display interface with the added operation control, if the captured display interface contains the content.

7. The device according to claim 6, wherein the instructions further cause the processor to:
determine whether the captured display interface contains a voice message, a video, music, text, or a picture.

8. The device according to claim 6, wherein the instructions further cause the processor to:
obtain a source of the content;
generate a link address corresponding to the content according to the source; and
display the link address as the operation control at a preset location of the captured display interface.

9. The device according to claim 8, wherein the instructions further cause the processor to:
display the content in response to receiving a trigger operation on the operation control.

10. The device according to claim 9, wherein the instructions further cause the processor to:
obtain the link address when receiving the trigger operation; and
obtain the content from the link address and displaying the obtained content.

11. A non-transitory computer-readable storage medium having stored therein instructions that, when executed by a processor of a device, cause the device to:
capture a display interface when detecting a capture operation instruction;
perform a content analysis on the captured display interface and determine whether the captured display interface contains content with a preset format; and
add an operation control corresponding to the content into the captured display interface and store the captured display interface with the added operation control, if the captured display interface contains the content.

12. The storage medium according to claim 11, wherein the instructions further cause the device to:
determine whether the captured display interface contains a voice message, a video, music, text, or a picture.

13. The storage medium according to claim 11, wherein the instructions further cause the device to:
obtain a source of the content;
generate a link address corresponding to the content according to the source; and
display the link address as the operation control at a preset location of the captured display interface.

14. The storage medium according to claim 13, wherein the instructions further cause the device to:
display the content in response to receiving a trigger operation on the operation control.

15. The storage medium according to claim 14, wherein the instructions further cause the device to:
obtain the link address when receiving the trigger operation; and
obtain the content from the link address and displaying the obtained content.
